(19) United States
(12) Patent Application Publication
(10) Pub. No.: US 2026/0359599 A1
(43) Pub. Date: Nov. 12, 2026

(54) METHOD AND APPARATUS FOR INTELLIGENT DATA PLANE BASED ON NEURAL NETWORK

(71) Applicant: TSINGHUA UNIVERSITY, Beijing (CN)

(72) Inventors: Zhuotao LIU, Beijing (CN); Haotian XU, Beijing (CN); Jinzhu YAN, Beijing (CN); Qi LI, Beijing (CN); Ke XU, Beijing (CN); Mingwei XU, Beijing (CN); Jianping WU, Beijing (CN)

(21) Appl. No.: 19/093,438

(22) Filed: Mar. 28, 2025

(30) Foreign Application Priority Data
Mar. 29, 2024 (CN) 202410372228.7

(51) Int. Cl. G06N 3/044; G06N 3/045

(52) U.S. Cl. CPC G06N 3/044; G06N 3/045

(57) ABSTRACT

A method for an intelligent data plane based on a neural network, includes obtaining a switch classification result by deploying a recurrent neural network on a P4 programmable switch to perform line-speed analysis on traffic; forwarding a first part of traffic to a server for upgraded analysis based on the switch classification result and a classification confidence; and performing the upgraded analysis on the first part of traffic by deploying a Transformer-based model on the server.

### CROSS-REFERENCE TO RELATED APPLICATION

This application claims priority to Chinese Patent Application No. 202410372228.7 filed on Mar. 29, 2024, the entire disclosure of which is hereby incorporated herein by reference.

### TECHNICAL FIELD

The disclosure relates to afield of network traffic analysis technology, and particularly to a solution design and an apparatus for an intelligent data plane based on a neural network.

### BACKGROUND

The development of a network programmable device drives research on performing traffic analysis by deploying an intelligent model in a network data plane. Conventional traffic analysis either directly deploys a model on an end-host to analyze traffic, or performs operations with the help of an auxiliary control plane after collects information from a data plane. By contrast, performing the traffic analysis directly on the network data plane, because the network data plane itself has a characteristic of processing and forwarding a packet at line-speed, may achieve a line-speed traffic analysis.

The exploration of deploying the intelligent model on the network data plane mainly focuses on an intelligent model with a tree structure, that is, a decision tree or a random forest model, because a decision-making process of the tree-based model is close to a match-action mechanism of a programmable data plane. However, the tree-based decision-making model needs to calculate a large number of statistical features, consumes a large amount of storage resources, and has a lower accuracy than a neural network in more complex tasks. Previously, there is a method for deploying a binary multilayer perceptron neural network on an intelligent network interface card, but a throughput of the intelligent network interface card is several orders of magnitude lower than that of a programmable switch. Such method may not be applied to the programmable switch due to consuming too much hardware resources.

In previous explorations, some methods put forward a concept of hybrid analysis. That is, some traffic is analyzed on the programmable data plane, and some traffic is sent to a large tree-based model on a server for analysis, but these explorations are not effectively designed and fail to accurately identify the traffic that should be sent to the server for analysis.

### SUMMARY

A first aspect of the disclosure provides a method for an intelligent data plane based on a neural network, including:

obtaining a switch classification result by deploying a recurrent neural network on a P4 programmable switch to perform line-speed analysis on traffic;

forwarding a first part of traffic to a server for upgraded analysis based on the switch classification result and a classification confidence; and

performing the upgraded analysis on the first part of traffic by deploying a Transformer-based model on the server.

A second aspect of the disclosure provides an electronic device, including:
a processor; and
a memory for storing instructions executable by the processor.

The processor is configured to:
obtain a switch classification result by deploying a recurrent neural network on a P4 programmable switch to perform line-speed analysis on traffic;
forward a first part of traffic to a server for upgraded analysis based on the switch classification result and a classification confidence; and
perform the upgraded analysis on the first part of traffic by deploying a Transformer-based model on the server

A third aspect of the disclosure provides anon-transitory computer-readable storage medium for storing computer instructions. The computer instructions are configured to cause a computer to execute the method in the above first aspect.

### BRIEF DESCRIPTION OF THE DRAWINGS

The disclosure's and/or additional aspects and advantages may become apparent and easily understood from following description of embodiments taken in combination with the accompanying drawings.

FIG. 1 is a logical schematic diagram illustrating a solution design for an intelligent data plane based on a neural network according to the disclosure.

FIG. 2 is a schematic diagram illustrating an architecture of a recurrent neural network implemented on a P4 programmable switch in a solution design for an intelligent data plane based on a neural network according to the disclosure.

FIG. 3 is a schematic diagram illustrating parameters and resource consumption of a recurrent neural network model on the P4 programmable switch in a solution design for an intelligent data plane based on a neural network according to the disclosure.

FIG. 4 is a schematic diagram illustrating the architecture of an integrated inference system in a solution design for an intelligent data plane based on a neural network according to the disclosure.

FIG. 5 is a schematic diagram illustrating a recurrent neural network expanding in a recurrent timestep in a solution design for an intelligent data plane based on a neural network according to the disclosure.

FIG. 6 is a schematic diagram illustrating accessing a low-dimensional embedded vector of a recurrent neural network module in a solution design for an intelligent data plane based on a neural network according to the disclosure.

FIG. 7 is a schematic diagram illustrating an alternative maximum selection ternary matching algorithm for an intermediate result aggregation module in a solution design for an intelligent data plane based on a neural network according to the disclosure.

FIG. 8 is a schematic diagram illustrating a reverse coding of only one bit in an alternative maximum selection ternary matching algorithm for an intermediate result aggregation module in a solution design for an intelligent data plane based on a neural network according to the disclosure.

### DETAILED DESCRIPTION

Reference will now be made in detail to embodiments of the disclosure, examples of which are illustrated in the accompanying drawings, in which, the same or similar numbers represent the same or similar elements or elements with the same or similar functions. Embodiments described below with reference to the accompanying drawings are exemplary, which are intended to explain the disclosure and do not be understood a limitation on the disclosure.

A solution design for an intelligent data plane based on a neural network according to embodiments of the disclosure includes the following.

S110: a switch classification result is obtained by deploying a recurrent neural network on a P4 programmable switch to perform line-speed analysis on traffic.

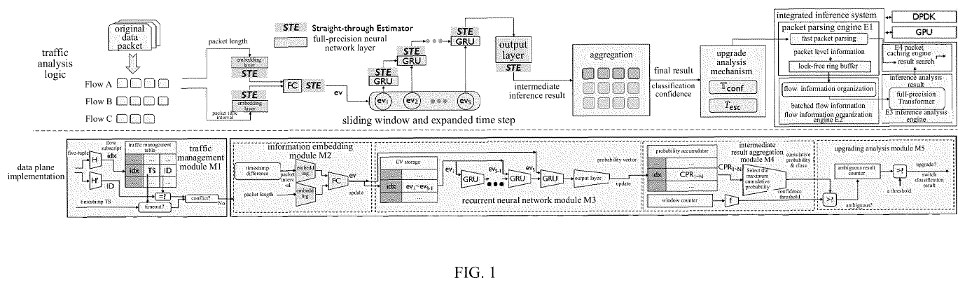

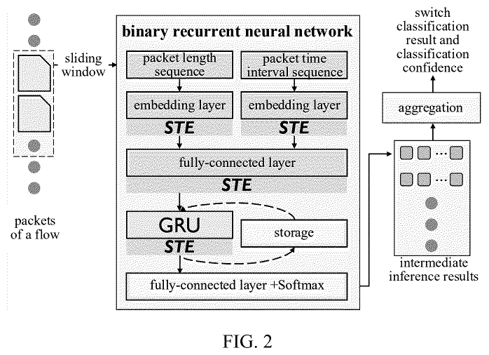

FIG. 1 is an overall logic diagram of the disclosure. English expressions appearing in FIG. 1 have the following meanings, and the English expressions repeated below may not be explained again. STE is an activation function described later. FC is a fully-connected neural network layer. GRU is one of a recurrent calculation unit. ev is an embedded vector, that is, a low-dimensional embedded vector, referred to as embedded vector. Subscript S is a size of a sliding window. T_{conf} and T_{esc} are two thresholds described later. DPDK is a data plane development kit. GPU is a graphics processor. Transformer is a machine learning model architecture. TS is a timestamp. H and H′ are hash functions. Idx is a flow subscript, which is used to mark a storage location of flow information. ID is a flow identifier, which marks a flow's identity, for example, a five-tuple. CPR is a cumulative probability. Subscript N is a classification number. An upper part of FIG. 2 is an overall logic of traffic analysis, which illustrates an overall analysis logic of a recurrent neural network and an integrated inference system on the P4 programmable switch. The left and the middle of FIG. 2 is the logic of the recurrent neural network in the switch, and the far right of FIG. 2 is a thumbnail of the integrated inference system. Sequence information of data packets of a flow in embodiments is a packet time interval, abbreviated as a packet interval, and a packet length. After the sequence information passes through an embedding layer and the fully-connected layer, the low-dimensional embedded vector is obtained. The sliding window maintains a low-dimensional embedded vector sequence in the switch storage, and performs continuous calculation by the recurrent calculation unit on the low-dimensional embedded vector sequence, which is the GRU in embodiments, and finally passes through an output layer to obtain intermediate inference results. Subsequently, the intermediate inference results are aggregated to obtain a switch classification result and a classification confidence. It is determined whether one flow requires to be performed upgraded analysis based on an upgrading analysis mechanism. In the case that one flow requires to be performed the upgraded analysis, the flow may be sent to the integrated inference system for the upgraded analysis, and details of the integrated inference system may be described below. A low part of FIG. 2 is a schematic diagram of the implementation of the recurrent neural network in the switch on the data plane, which is described in detail below.

As illustrated in FIG. 1, the recurrent neural network in the switch in embodiments of the disclosure includes following modules.

A traffic management module M1, configured to allocate an array subscript of storing flow information based on a hash value, and to update and maintain the flow information. The traffic management module M1 calculates the hash value based on five-tuple information of the flow [source, IP address-destination, IP address-source, port-destination, port-protocol type], determines the hash value as the array subscript of storing the flow information, stores a flow identifier and a timestamp of a last packet, and updates and maintains stored flow information based on a condition whether the flow identifier conflicts and whether the timestamp is timed out.

An information embedding module M2, responsible for embedding the sequence information of the flow into a low-dimensional vector. The information embedding module M2 embeds a sequence feature of the flow, such as a packet length sequence, a packet time interval sequence and other feature sequence, into a low-dimensional vector sequence by look-up table;

A recurrent neural network module M3, responsible for obtaining the intermediate inference results by inference analysis of the recurrent neural network based on the low-dimensional vector sequence embedded. The recurrent neural network module M3 obtains the intermediate inference results based on the low-dimensional vector sequence, when which is implemented, the number of preset timesteps is limited based on a hardware resource, and a length of the sliding window is preset based on the number of preset timesteps. For the low-dimensional vector obtained by the information embedding module M2, the recurrent neural network module M3 stores the low-dimensional vector and updates a low-dimensional vector sequence within the sliding window, and continuously performs calculation on the recurrent neural network with the calculation number equivalent to the number of timesteps for the low-dimensional sequence by look-up table, to ultimately obtain the intermediate inference results.

An intermediate result aggregation module M4, responsible for aggregating the intermediate inference results. The intermediate inference results calculated by the recurrent neural network module M3 are aggregated with a sequence formed by window sliding, to obtain a switch classification result and a classification confidence. The intermediate result aggregation module M4 may select a maximum cumulative value as the switch classification result and the classification confidence, and employ an optimized ternary coding algorithm to compress the number of steps required to select a maximum value.

An upgrading analysis module M5, configured to determine whether to upgrade the analysis of the flow based on the switch classification result and the classification confidence.

S120: a first part of traffic with a classification confidence lower than a set classification confidence threshold is screened based on the switch classification result

The upgrading analysis module M5 compares the classification confidence of the switch classification result obtained by the intermediate result aggregation module M4 with a preset confidence threshold. In the case that the classification confidence is lower than the confidence threshold, it is determined that the switch classification result is ambiguous. In the case that a number of ambiguous switch classification results exceeds a preset threshold, subsequent traffic is forwarded to the server, and upgraded analysis is performed by employing a Transformer-based model.

S130: upgraded analysis is performed on the first part of traffic by deploying a Transformer-based model on a server, thus improving a classification accuracy.

According to a traffic analysis method in the disclosure, when a Transformer-based model deployed on the server to perform the upgraded analysis on the first part of the traffic with the classification confidence lower than a preset classification confidence threshold, DPDK is employed to accelerate a packet processing process, and multiple analysis engines are created based on RSS multi-queue receiving, including:
a packet parsing engine E1, responsible for taking an original data packet from the network interface card and obtaining data parsed from the original data packet;
a flow information organization engine E2, responsible for taking the parsed data based on the flow;
an inference analysis engine E3, responsible for inference analysis based on data of each flow;
a packet caching engine E4, responsible for caching the packet and sending the packet after a classification result is obtained.

The above engines form a non-blocking packet processing pipeline.

Further, the packet parsing engine E1 calls a DPDK interface to obtain a data packet from the network interface card, parses and extracts information required for the inference analysis, transmits the extracted information to the flow information organization engine E2, and transmits the original data packet and the data parsed from the packet to the packet caching engine E4.

The flow information organization engine E2 obtains the information extracted from the parsed data from the packet parsing engine E1, and organizes a flow determined by the five-tuple [source, IP address-destination, IP address-source, port-destination, port-protocol type] as a unit to form the information of each flow. When the inference analysis engine E3 requires input, the information required for inference analysis is delivered in batches by taking the flow as a unit.

The inference analysis engine E3 obtains batched inputs required for the inference analysis from the flow information organization engine E2, obtains batched inference analysis outputs after the inference analysis of the Transformer-based model, and transmits the batched inference analysis output to the packet caching engine E4.

The packet caching engine E4 obtains and caches the batched classification results from the inference analysis engine E3, obtains the original data packet from the packet parsing engine E1, caches a data packet that requires to wait for a classification result, and sends a data packet of which the classification result is queried in the cache.

FIG. 2 illustrates an architecture of a recurrent neural network implemented on a P4 programmable switch according to the disclosure. The recurrent neural network may directly receive sequence information of an original flow as input. In embodiments, an input sequence is a packet length sequence and a packet time interval sequence. When the sequence information is input, the packet length sequence and the packet time interval sequence may pass through the embedding layer and then through the fully-connected layer respectively, and be embedded into the low-dimensional vector, and then recurrently passes through a recurrent calculation unit. In embodiments, GRU, a recurrent calculation unit commonly used in the recurrent neural network, is employed. Finally, in a traffic classification task, an output layer is combined by the fully-connected layer and a softmax function. In embodiments, the recurrent neural network is a binary recurrent neural network, and all activation functions are set to a straight-through estimator (STE) function. The effect is that an input is mapped to 1 or −1 based on whether the input is greater than zero in a forward propagation, while a gradient between −1 and 1 is kept unchanged in a backward propagation, and a gradient less than −1 becomes −1, and a gradient greater than 1 becomes 1. In the inference analysis of the data plane, the input of the neural network layer such as an embedding layer, a fully-connected layer and a GRU, and an output subjected to the activation function are regarded as a bit string. A mapping relationship between an input bit string and an output bit string is obtained based on a pre-trained model. The mapping relationship is stored as a table in P4 language whose size is 2 to the power of the input bit string length, and the forward propagation is executed by looking the table for an output bit string using the input bit string as the key. For a case that the recurrent neural network is not binary, such as quaternary, octal, or more, the execution of the forward propagation is still the mapping of the input bit string to the output bit string, and there is no difference in the detailed implementation of the P4 programmable switch.

The recurrent execution of the recurrent calculation unit of the recurrent neural network requires a function to store, to read and to update a memory value, but limited by the architecture of the P4 programmable switch, such function may not be directly realized by using a register. Therefore, the disclosure designs an expansion of a recurrent timestep of the recurrent calculation unit, where a series of timestep computations are executed across multiple processing stages in the switch pipeline. Since the P4 programmable switch has a limited number of pipeline stages, which consequently restricts the number of expanded timesteps, a sliding window mechanism is employed in the disclosure. The sliding window mechanism maintains: a sliding window of a size S along the input sequence, and the low-dimensional embedded vectors of the sequence within the window. For each window position, computation of S timesteps are performed continuously solely on the window's low-dimensional embedded vectors, and finally the intermediate inference result is obtained through the output layer. The historically obtained intermediate inference results are aggregated to obtain the switch classification result.

For the traffic classification task, a class with a maximum cumulative probability may be selected by an intermediate result aggregation algorithm, but there may be a situation where no class has a significantly higher cumulative probability than the others, which is also called an ambiguous switch classification result. In this case, a class with the maximum cumulative probability may reduce the classification confidence. Thus, in the disclosure, the Transformer-based model deployed on the server is designed to perform the upgraded analysis on a small amount of traffic that is difficult to determine the classification result in the switch. However, there are two major challenges. First, an aggregation algorithm may be carefully designed to capture traffic with the ambiguous switch classification results as accurately as possible, such that the upgraded analysis is only performed on the small amount of traffic on the server, while the line-speed analysis of a most amount of traffic in the switch is ensured. Second, for the upgraded analysis model, the Transformer-based model is employed to improve the accuracy, but it is non-trivial to improve the throughput of the inference analysis and maintain high-speed network forwarding because of the complicated calculation of the model analysis.

For the first challenge, in the disclosure, the classification confidence of the switch classification result is measured in the aggregation algorithm. For each class, in the disclosure, probabilities of the class in previous intermediate inference results are accumulated, and the class with the maximum cumulative probability is determined as a switch classification result. In the disclosure, the classification confidence is a result obtained by the cumulative probability of the switch classification result divided by the number of intermediate inference results accumulated, and a threshold T_{conf} is set. In the case that the classification confidence is less than T_{conf}, the switch classification result is ambiguous. When the number of ambiguous switch classification results of a flow is greater than another preset threshold T_{esc}, the subsequent traffic may be forwarded to the Transformer-based model for the upgraded analysis.

The T_{conf} and T_{esc} thresholds are obtained from a distribution of the classification confidences of training samples, and the setting of T_{conf} may identify misclassified and correctly classified samples based on the difference in the classification confidence. During the training, it is assumed that pᵢ is a probability of a class i predicted by the recurrent neural network, and y is a real class. A classic cross-entropy loss function CE is defined CE=−log(p_{y}). The loss function only considers a capability of improving a model to predict a correct classification. In the disclosure, the loss function during the training is defined as

$${L}_{1} = - {( 1 - {p}_{y} )}^{γ} log ( {p}_{y} ) - λ {\sum }_{i \neq y} {p}_{i}^{γ} log ( ( 1 - {p}_{y} ) ,$$

strengthening a confidence gap between correct classification and misclassification, where (1−p_{y})^{γ} and [symbol] represent two weights, proposed by Focal Loss, and the loss function may focus on a sample with high classification difficulty. Since the aggregation algorithm in this embodiment only selects the classification with the maximum cumulative probability, the loss function may be simplified as

$${L}_{2} = - {( 1 - {p}_{y} )}^{γ} log ( {p}_{y} ) - λ {p}_{f a l s e}^{γ} log ( ( 1 - {p}_{f a l s e} ) ,$$

where p_{false} represents a maximum pᵢ in the incorrect classification. After T_{conf} is obtained based on distribution of the classification confidence on the training set, T_{esc} is set to ensure that the upgraded traffic is not more than a certain ratio, for example, the upgraded analysis is performed on 5% of the traffic.

For the second challenge, in the disclosure, an integrated inference system is designed, and the Transformer-based model deployed on the server performs rapid online traffic analysis, with four types of single-threaded tasks also called engines, thus realizing a non-blocking packet analysis pipeline. Details may be introduced later.

The implementation details of the recurrent neural network on the P4 programmable switch are explained with reference accompanying drawings below. The traffic management module M1 is described first. Because traffic analysis requires to maintain state information of each flow, there requires to assign a storage location subscript to each flow, which is called flow subscript for short. In the previous methods, the flow subscript is allocated by means of the control plane. In order to realize the line-speed traffic analysis, the disclosure discloses employing an allocation method based on the hash function. In detail, a subscript of a flow F is a result which is obtained by the hash function H taking the five-tuple of F as the input and modulo the maximum number of supported flows, that is, H(F(five-tuple)% the maximum number of supported flows). The Hash function and modulo may introduce collision, that is, two flows with different five-tuples are allocated to the same flow subscript by the hash function. In order to avoid confusion, in this embodiment, the 2-tuple of [flow identifier, timestamp] is recorded in a corresponding subscript location in a traffic management table. Because the five-tuple is too long to be stored directly in the switch, another hash function H′ is employed to calculate the value obtained by H′(F(five-tuple)) as the flow identifier in this embodiment. The timestamp is a time point when a latest packet of the flow arrived at the switch. When the flow subscripts conflict, the disclosure allows a new flow to take the place and occupy the location if and only if an old flow is timed out, that is, an interval between the time point of the latest packet and a current time point exceeds a preset threshold. Otherwise, in the case that the new flow fails to occupy the location, the new flow may be fallen back to a model trained only by features of a single package, or upgraded analysis is performed when the integrated inference system has sufficient computing power. In the embodiment, training the model based on features of a single package may employ a decision tree model or a random forest model used in the previous exploration.

The information embedding module M2 and the recurrent neural network module M3 have had their core design components previously described during the introduction of the inference process of the recurrent neural network above. Herein, the implementation of the sliding window in the programmable switch, that is, the maintenance, storage and retrieval of the low-dimensional embedded vector in the sliding window are introduced. As illustrated in FIG. 5, the length of the sliding window is S, and embedded vectors in the sliding window are recorded as ev₁ to ev_{S} in turn. After the recurrent timestep is expanded, the recurrent calculation unit is also expanded into S units, which are recorded as GRU₁ to GRUₛ in turn from front to back, and an implicit state hₛ is obtained from an initial calculation h₀=\vec{0}. Consider a window from the beginning of the k^{th} packet to the end of the (k+S−1)^{th} packet. When the (k+S−1)^{th} packet arrives, the window is full, and the calculation of continuous S timesteps may be performed in the window. Therefore, before one window is filled, embedded vectors of previous S−1 packets require to be saved. In the disclosure, a ring buffer with a size of S−1 is employed to save these embedded vectors, and the storage location is recorded as bin₁ to binₛ₋₁. In detail, an embedded vector of the k^{th} packet may be stored in the (k%(S−1)+1)^{th} bin, so an embedded vector of the (k+S−1)^{th} packet may occupy a storage location of an embedded vector of the original k^{th} packet, because the embedded vector of the k^{th} packet is useless when the (k+S)^{th} packet arrives. The advantage of such design is that each bin is independent of each other and may be accessed and stored in parallel. Such storage solution may bring challenges to reading the embedded vector. Since the first embedded vector ev₁ within the window may not be stored in the first bin, it is impossible to statically transfer an embedded vector read from binₖ to GRUₖ for calculation. In detail, the embedded vector required by the input of the i^{th} GRU (i∈[1, S−1]) is stored in the ((k−S+1)%(S−1)+1)^{th} bin. Because a storage location of a keyword should be statically specified when a table corresponding to the GRU is declared in the P4 programmable switch, as illustrated in FIG. 6, the embedded vector requires to be read from the bin into an intermediate variable called metadata first, and then the metadata is distributed to a correct GRU table.

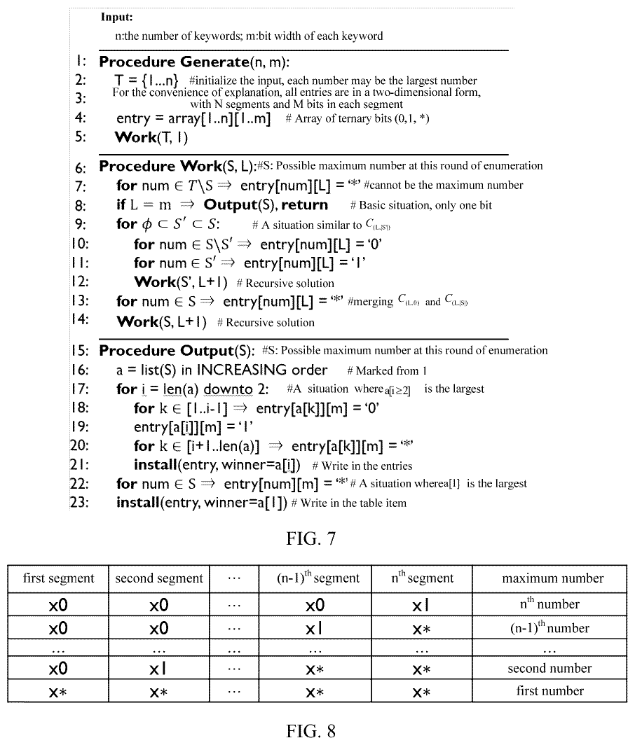

Intermediate result aggregation module M4. In embodiments, multi-classification tasks are presented, and the classification with the maximum cumulative probability is selected as the switch classification result, and the cumulative probability of the corresponding class is divided by the number of accumulated windows, i.e., the number of intermediate inference result accumulated, to obtain a result as confidence. In order to avoid accumulation overflow, in embodiments, the cumulative probability and the number of accumulated windows are periodically cleared. The remaining main problem is how to find the class with the maximum cumulative probability and the cumulative probability of the class among the cumulative probabilities of multiple classes, which is similar to argmax operation. The argmax operation refers to find a subscript of a maximum element in an array. However, argmax is not supported on the switch. Pairwise comparison requires excessive pipeline stages. In lookup-table-based matching methods, exact matching demands prohibitive table entries, while basic ternary matching algorithms still require substantial table entries, making scalability challenging. Therefore, the disclosure proposes a new argmax algorithm based on ternary matching. In ternary matching, each bit in the entry has three kinds: 0, 1 and *, where * is a wildcard and may match both 0 and 1. In a ternary matching table, because there may be multiple kinds of entries that may match the keyword, a priority of the entry is specified. In the case that the entries are written in a generation order of the entries, the earlier the entry is generated, the higher the priority is. In the ternary matching table designed by the disclosure, the keyword includes cumulative probabilities of classes to be compared, and a value of the entry is the class with the maximum cumulative probability in the corresponding situation. For the sake of simplifying the explanation, the class with a small numeral is selected when the cumulative probabilities are tied for the maximum value. It is assumed that n numerals are compared, each numeral has m binary bits, then the keyword has n segments. Each segment corresponds to a numeral, and there are m ternary bits, which may be one of 0.1 and *. A possibility of each bit is recursively enumerated from a highest bit of each segment to a lowest bit, that is, an m^{th} bit. At the first bit, there are 2ⁿ possibilities. It is considered that the first k segments take 1 and the last n−k segments take 0, which is recorded as C_{(l,k)}, so it is obvious that the last n−k numeral may not be the maximum value, and further enumerating situations from the (l+1)^{th} bit to the m^{th} bit for the last n−k segments are not required. Therefore, for 2^{(m-l)n} sub-situations of C_{(l,k)}, there is no need to further enumerate after 2^{(m-l)k} sub-situations are enumerated, and an enumeration space is reduced by 2^{(m-l)(n-k)} times. Based on such idea, a recursive program may be written to generate the entries, but there is still a considerable quantity of entries. The disclosure further discloses two optimizations for the algorithm. A first optimization is to observe two extreme situations C_{(l,0)} and C_{(l,n)}, that is, the l^{th} bit position in each segment is fully enumerated as all zeros or all ones, and their subsequent enumeration may be merged. That is, for each sub-situation of C_{(l,0)}, in the case that all the l^{th} bits are changed from 0 to 1, a subscript of a maximum numeral remains unchanged. Similarly, for each sub-situation of C_{(l,n)}, in the case that all the l^{th} bits are changed from 0 to 1, a subscript of a maximum numeral remains unchanged. Thus, the two situations may be merged by filling the l^{th} bit with the wildcard *. In order to avoid other situations where the wildcard is incorrectly matched to non-all 0 and non-all 1, this algorithm enumerates remaining 2ⁿ−2 possibilities of the l^{th} bit and generates corresponding entries, and then enumerates a merged situation of C_{(l,0)} and C_{(l,n)}, and generates corresponding entries, to ensure that a priority of a wildcard entry is lower. The second optimization is that, for a situation of m=1, this algorithm designs a reverse coding mode, such that only n entries are required to complete the matching, as illustrated in FIG. 8, where x is a common prefix of each segment. FIG. 7 is a pseudo code of the whole algorithm, which may be proved by a mathematical induction. The number of entries generated by this algorithm is nmⁿ⁻¹, which is significantly better than an exact matching algorithm and an unoptimized version.

The upgrading analysis module M5, the main body of which has been introduced before when the inference architecture of the recurrent neural network is introduced. Because it is not convenient to perform division operation in the switch, when the classification confidence and the threshold T_{conf} are compared, it is converted into a comparison of the cumulative probability and a product of the number of accumulated windows and the threshold. When a flow is confirmed to be upgraded, that is, the number of ambiguous switch classification results exceeds the threshold T_{esc}, in order to enable the traffic to be forwarded to the integrated inference system for the upgraded analysis, there requires to maintain an upgrade analysis flag, which is also realized by a register in the switch.

In this embodiment, the maintenance of the embedded vector within the sliding window requires to know an ordinal position of a packet in the flow to which the packet belongs, that is, a sequence number of the packet. There requires to determine whether the packet is the first S−1 packets during the inference analysis, and the first S−1 packets are not analyzed or the inference analysis is performed by a model trained based on features of a single packet, which requires a packet counter. However, the counter may overflow. Therefore, in embodiments, the packet counter is split into two counters. The first counter is responsible for calculating the result of the packet sequence number module S−1 for the storage and retrieval of the embedded vector mentioned above, and the second counter is responsible for adding 0 to S and stopping at S to determine whether S packets are full or not for being queried by an inference analysis related module.

In this embodiment, the P4 programmable switch takes a Tofino1 switch as an example. FIG. 3 illustrates a dependency relationship, hyper-parameter and pipeline processing stage of respective components of the recurrent neural network in the switch in embodiments, that is, the use of stage. In embodiments, the tables corresponding to the first two GRU calculation units are merged, that is, h=GR U₂(GR U₁(0, ev₁), ev₂) is merged into h=(GR U₂∘GRU₁)(0,ev₁,ev₂). Similarly, the output layer is merged with GRU₈, that is, h=Output(GRU₈(h,ev₈)) is merged into (Output∘GRU₈)(h,ev₈). Because there are the fewer number of stages in Tofino1, only 12, pipelines of both ingress and egress required to be used simultaneously. In embodiments, the traffic management is only performed in the ingress stage. In order to avoid flow without flow subscript conflict in multiple ingress stages from entering the same egress pipeline to generate the flow subscript conflict, the pipelines of the egress and ingress are bound one to one. Meanwhile, a forwarding destination of packet needs to be determined at the ingress stage on the Tofino1 programmable switch, and whether the upgrade analysis flag is updated in embodiments is determined at the egress stage. Therefore, a mirror+recirculate mechanism is employed for updating the upgrade analysis flag, and the upgrade analysis flag is maintained at the ingress stage.

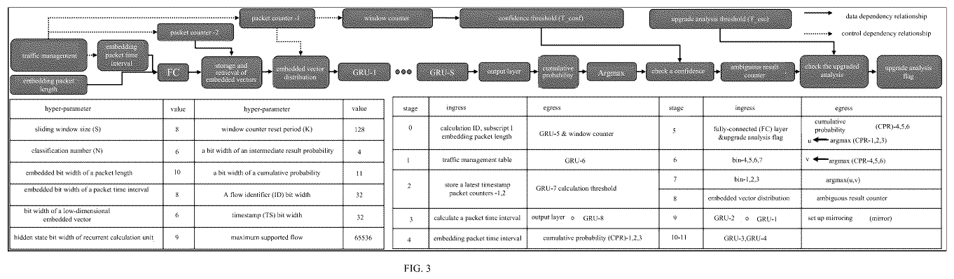

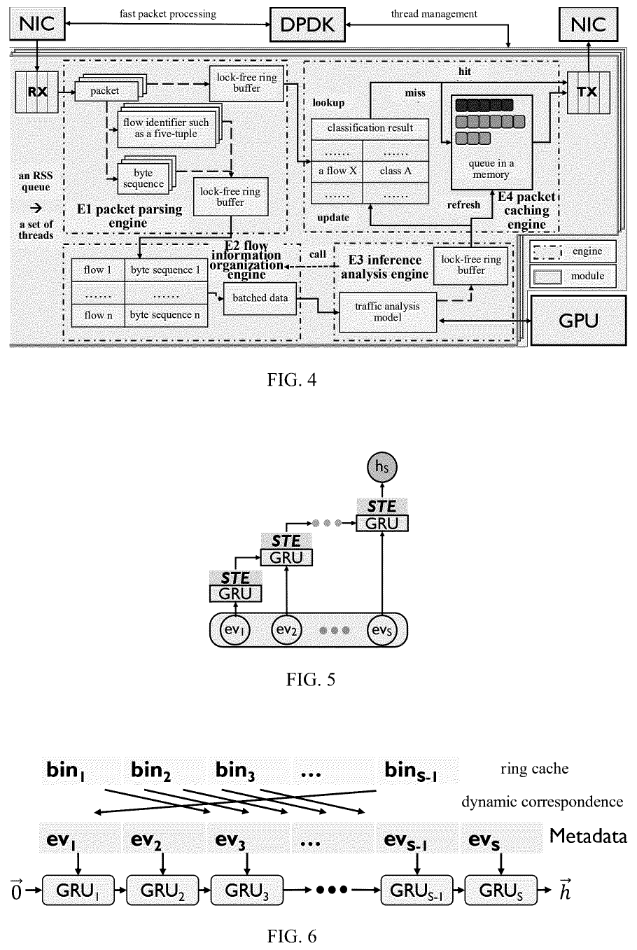

Description is made below to the integrated inference system in embodiments with reference to accompanying drawings. The purpose of the integrated inference system is to enable the Transformer-based model to perform online inference analysis with high inference analysis throughput and forwarding ability. In embodiments, the Transformer-based model employs a YaTC proposed recently, that is, a Transformer model for network traffic based on an MAE, that is, a masked auto encoder. The input for the inference analysis is first five packets of a flow, with first 80 packet header bytes and first 240 payload bytes of each packet, and insufficient bit being padded with zero. FIG. 4 illustrates a schematic diagram of an architecture of the integrated inference system. The new English explanations in the drawing are as follows. NIC is network interface card. RX refers to the reception of the network interface card. TX refers to sending of the network interface card. RSS is receive-side scaling, a technology with which the receiving traffic of network interface card is effectively distributed to multiple receiving queues. The disclosure employs data plane development kit of Intel, i.e., DPDK, to create multiple receiving and sending queues for the network interface card, each group of receiving and sending queues is bound with an analysis module, and RSS technology is employed to effectively distribute upgraded traffic received by the network interface card to an analysis module corresponding to each receiving queue. Each analysis module consists of four single-threaded tasks called engines, which are respectively called packet parsing engine E1, flow information organization engine E2, inference analysis engine E3 and packet caching engine E4. The above engines form a non-blocking packet processing pipeline. The engines and a relationship of the engines are described in the following examples.

The packet parsing engine E1 employs an interface provided by the DPDK to parse a flow identifier of a data packet, such as five-tuple, and an original byte sequence required for inference analysis. The packet parsing engine E1 stores parsed content in a lock-free ring buffer, and the flow information organization engine E2 obtains the parsed content from the lock-free ring buffer and organizes the parsed content based on the flow. After the packet parsing engine E1 parses the content required by inference analysis of the data packet, the data packet is put into another lock-free ring buffer. The data packet is obtained by the packet caching engine E4 and sent based on the classification result. In embodiments, the Transformer-based model only employs an original byte sequence of first five packets of one flow, so subsequent packets of the flow directly enter the lock-free ring buffer and go to the packet caching engine E4, without parsing the original byte sequence from the data packet.

The flow information organization engine E2 converts the streaming parsing results transmitted by the packet parsing engine E1 into batched model inputs to facilitate efficient batch processing during model analysis. In detail, the flow information organization engine E2 continuously organizes streaming parsing results transmitted by the packet parsing engine E1 through the lock-free ring buffer into data of each flow based on the flow identifier. When receiving a call from the inference analysis engine E3, the flow information organization engine E2 selects a flow based on the timestamp of the flow to form a batch of data, and sends the batch of data to the inference analysis engine E3. In embodiments, in the case that a selected flow has less than 5 packets, the flow information organization engine E2 may fill in zeros at the end of the flow, and the classification result this time is considered as a temporary result and such flow may be selected in a following selection.

To speed up the analysis process, the inference analysis engine E3 employs a CUDA architecture proposed by an NVIDIA to interact with a GPU which assists the analysis calculations. The inference analysis engine E3 continuously calls the flow information organization engine E2 to request the batch of data. Once the batch of data is obtained, the inference analysis engine E3 performs the model analysis on the GPU and sends the classification result to the lock-free ring buffer received by the packet caching engine E4.

The packet caching engine E4 continuously obtains a latest classification result from the inference analysis engine E3 through the lock-free ring buffer, and releases a cached data packet based on the classification result. When the data packet from the packet parsing engine E1 is received, it is first checked whether there is a classification result. If there is the classification result, the data packet is released immediately. Otherwise, the data packet enters a waiting queue of the flow to which the data packet belongs and waits for the classification result. Once the packet caching engine E4 receives a classification result of a certain flow from the inference analysis engine E3, the packet caching engine E4 may directly release all the data packets in the waiting queue of the flow.

In addition, the disclosure provides an apparatus for an intelligent data plane based on a neural network, including:
a preliminary analysis module, configured to obtain a switch classification result by deploying a recurrent neural network on a P4 programmable switch to perform line-speed analysis on traffic;
a filter module, configured to filter out a first part of traffic with a classification confidence lower than a preset classification confidence threshold based on the switch classification result; and
an upgraded analysis module, configured to perform upgraded analysis on the first part of traffic by deploying a Transformer-based model on a server, thus improving a classification accuracy.

In order to realize the embodiments, the disclosure also provides an electronic device, includes at least one processor; and a memory communicatively connected with the at least one processor. The memory is configured to store instructions executable by the at least one processor. The instructions are executed by the at least one processor, to enable the at least one processor to execute the steps in the above technical solution.

In order to realize the embodiments, the disclosure also provides a non-transitory computer-readable storage medium for storing a computer program. When the computer program is executed by a processor, the method steps of the embodiments of the disclosure are realized.

In the description of the disclosure, reference “an embodiment,” “some embodiments,” “an example,” “a specific example,” or “some examples,” means that a particular feature, structure, material or feature described in connection with the embodiment or example is included in at least one embodiment or example of present disclosure. The appearances of the above phrases throughout this specification are not necessarily referring to the same embodiment or example. Moreover, the detailed features, structures, materials or characteristics described may be combined in any one or more embodiments or examples in a suitable manner. Furthermore, without contradicting each other, the skilled in the art may combine different embodiments or examples described in this specification and features of different embodiments or examples.

In addition, the terms “first” and “second” are only for description purpose, and cannot beunderstoodasindicatingorimplyingrelativeimportanceorimplicitly indicating the number of indicated technical features. Therefore, the features defined with “first” and “second” can include at least one of the features explicitly or implicitly. In addition, in the description of the disclosure, the term “a plurality of” means two or more, such as two and three, unless specified otherwise.

Any procedure or method described in a flow chart or described herein in other ways may be understood to include one or more modules, segments or portions of codes of executable instructions for achieving specific logical functions or steps in the procedure, and the scope of a preferred embodiment of the disclosure includes other implementations. The order of execution is different from that which is depicted or discussed, including executing functions in a substantially simultaneous manner or in an opposite order according to the related functions, which should be understood by those skilled in the art which embodiments of the disclosure belong to.

The logic and/or step described in other manners herein or illustrated in the flow chart, for example, a particular sequence table of executable instructions for realizing the logical function, may be specifically achieved in any computer readable medium to be used by the instruction execution system, device or equipment (such as the system based on computers, the system including processors or other systems capable of obtaining the instruction from the instruction execution system, device and equipment and executing the instruction), or to be used in combination with the instruction execution system, device and equipment. As to the specification, “the computer readable medium” may be any device adaptive for including storing, communicating, propagating or transferring programs to be used by or in combination with the instruction execution system, device or equipment. More detailed examples of the computer readable medium include, but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memory.

It should be understood that each part of the disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above embodiment method may be achieved by commanding the related hardware with a program. The program may be stored in a computer readable storage medium, and the program includes one or a combination of the steps in the method embodiments when operated on a computer.

In addition, each function unit of each embodiment of the disclosure may be integrated in a processing module, or these units may be separate physical existence, or two or more units are integrated in a processing module. The integrated module may be realized in a form of hardware or in a form of software function modules. When the integrated module is realized in the form of software function module and is sold or used as a standalone product, the integrated module may be stored in a computer readable storage medium.

The storage medium mentioned above may be a read-only memory, a magnetic disk or CD, etc. Although embodiments of the disclosure have been illustrated and described above, it should be understood that the above embodiments are exemplary and should not be construed as limiting the disclosure. The skilled in the art can make changes, modifications, substitutions and variations to the above embodiments within the scope of the disclosure.

What is claimed is:

1. A method for an intelligent data plane based on a neural network, comprising:
obtaining a switch classification result by deploying a recurrent neural network on a P4 programmable switch to perform line-speed analysis on traffic;
forwarding a first part of traffic to a server for upgraded analysis based on the switch classification result and a classification confidence; and
performing the upgraded analysis on the first part of traffic by deploying a Transformer-based model on the server.

2. The method of claim 1, wherein deploying the recurrent neural network on the P4 programmable switch to perform the line-speed analysis on the traffic comprises:
allocating an array subscript for storing flow information based on a hash value, and updating and maintaining the flow information;
embedding sequence information of a flow into a low-dimensional vector;
obtaining intermediate inference results by inference analysis of the recurrent neural network based on the low-dimensional vector sequence embedded;
aggregating the intermediate inference results to obtain the switch classification result and the classification confidence; and
determining whether the upgraded analysis is performed based on the switch classification result and the classification confidence.

3. The method of claim 2, wherein allocating the array subscript for storing the flow information based on the hash value and updating and maintaining the flow information comprise:
calculating the hash value as the array subscript for storing the flow information based on five-tuple information [source, IP address-destination, IP address-source, port-destination, port-protocol type] of the flow;
storing a flow identifier and a timestamp of a last packet; and
updating and maintaining stored flow information by determining whether the flow identifier conflicts and whether the timestamp is timed out.

4. The method of claim 2, wherein the sequence information is a packet length sequence and/or a packet time interval sequence of the flow; embedding the sequence information of the flow into the low-dimensional vector is embedding the packet length sequence and/or the packet time interval sequence into the low-dimensional vector sequence by look-up table.

5. The method of claim 2, wherein obtaining the intermediate inference results by the inference analysis of the recurrent neural network based on the low-dimensional vector sequence embedded comprises:
setting a number of recurrent timesteps based on a hardware resource, and setting a length of a sliding window based on the number of recurrent timesteps;
storing the low-dimensional vector and updating a low-dimensional vector sequence within the sliding window; and
for the low-dimensional vector sequence, performing analysis calculations of recurrent timesteps continuously by look-up table to obtain the intermediate inference results.

6. The method of claim 2, wherein aggregating the intermediate inference results to obtain the switch classification result and the classification confidence and determining whether the upgraded analysis is performed based on the switch classification result and the classification confidence comprise:
accumulating probabilities of each class in the intermediate inference results, selecting a class with a maximum cumulative probability as the switch classification result, and calculating the classification confidence based on a cumulative probability of the switch classification result and a number of intermediate inference results;
compressing a number of steps required to select the maximum cumulative probability by using an optimized ternary coding algorithm; and
comparing the classification confidence of the switch classification result with a preset confidence threshold, wherein in a case that the classification confidence is lower than the preset confidence threshold, the switch classification result is considered to be ambiguous; in a case that a number of ambiguous switch classification results exceeds a preset threshold, subsequent flow is forwarded to the server, and the Transformer-based model is employed for the upgraded analysis.

7. The method of claim 1, wherein performing the upgraded analysis on the first part of traffic by deploying the Transformer-based model on the server comprises:
speeding up a packet processing by employing a data plane development kit (DPDK), and creating a plurality of analysis modules based on receive-side scaling (RSS) multi-queue receiving,
wherein each analysis module comprises:
a packet parsing engine, configured to obtain an original data packet and packet parsing data by packet parsing; wherein the packet parsing engine calls a DPDK interface to obtain the original data packet from a network interface card, and then parses the original data packet and extracts information required for inference analysis;
a flow information organization engine, configured to sort the packet parsing data based on flows; wherein the flow information organization engine obtains the information extracted from the packet parsing data from the packet parsing engine, organizes the information extracted into information of each flow by taking a flow determined by a five-tuple [source, IP address-destination, IP address-source, port-destination, port-protocol type] as a unit, and transmits the information required for the inference analysis in batches by taking the flow as the unit;
an inference analysis engine, configured to perform the inference analysis based on data of each piece of flow; wherein the inference analysis engine obtains batched inputs required by the inference analysis from the flow information organization engine, and obtains a batch of classification results after performing the inference analysis on the batched inputs by the Transformer-based model; and
a packet caching engine, configured to cache a packet and send the packet after obtaining the batch of classification results; wherein the packet caching engine obtains and caches the batch of classification results from the inference analysis engine, obtains the original data packet from the packet analysis engine, caches a data packet that requires to wait for the classification result, and sends a data packet of which a classification result is queried in the cache.

8. An electronic device, comprising:
a processor; and
a memory for storing instructions executable by the processor;
wherein the processor is configured to:
obtain a switch classification result by deploying a recurrent neural network on a P4 programmable switch to perform line-speed analysis on traffic;
forward a first part of traffic to a server for upgraded analysis based on the switch classification result and a classification confidence; and
perform the upgraded analysis on the first part of traffic by deploying a Transformer-based model on the server.

9. The electronic device of claim 8, wherein the processor is configured to:
allocate an array subscript for storing flow information based on a hash value, and update and maintaining the flow information;
embed sequence information of a flow into a low-dimensional vector;
obtain intermediate inference results by inference analysis of the recurrent neural network based on the low-dimensional vector sequence embedded;
aggregate the intermediate inference results to obtain the switch classification result and the classification confidence; and
determine whether the upgraded analysis is performed based on the switch classification result and the classification confidence.

10. The electronic device of claim 9, wherein the processor is configured to:
calculate the hash value as the array subscript for storing the flow information based on five-tuple information [source, IP address-destination, IP address-source, port-destination, port-protocol type] of the flow;
store a flow identifier and a timestamp of a last packet; and
update and maintain stored flow information by determining whether the flow identifier conflicts and whether the timestamp is timed out.

11. The electronic device of claim 9, wherein the sequence information is a packet length sequence and/or a packet time interval sequence of the flow; embedding the sequence information of the flow into the low-dimensional vector is embedding the packet length sequence and/or the packet time interval sequence into the low-dimensional vector sequence by look-up table.

12. The electronic device of claim 9, wherein the processor is configured to:
set a number of recurrent timesteps based on a hardware resource, and set a length of a sliding window based on the number of recurrent timesteps;
store the low-dimensional vector and update a low-dimensional vector sequence within the sliding window; and
for the low-dimensional vector sequence, perform analysis calculations of recurrent timesteps continuously by look-up table to obtain the intermediate inference results.

13. The electronic device of claim 9, wherein the processor is configured to:
accumulate probabilities of each class in the intermediate inference results, select a class with a maximum cumulative probability as the switch classification result, and calculate the classification confidence based on a cumulative probability of the switch classification result and a number of intermediate inference results;
compress a number of steps required to select the maximum cumulative probability by using an optimized ternary coding algorithm; and
compare the classification confidence of the switch classification result with a preset confidence threshold, wherein in a case that the classification confidence is lower than the preset confidence threshold, the switch classification result is considered to be ambiguous; in a case that a number of ambiguous switch classification results exceeds a preset threshold, subsequent flow is forwarded to the server, and the Transformer-based model is employed for the upgraded analysis.

14. The electronic device of claim 8, wherein the processor is configured to:
speed up a packet processing by employing a data plane development kit (DPDK), and create a plurality of analysis modules based on receive-side scaling (RSS) multi-queue receiving,
wherein each analysis module comprises:
a packet parsing engine, configured to obtain an original data packet and packet parsing data by packet parsing; wherein the packet parsing engine calls a DPDK interface to obtain the original data packet from a network interface card, and then parses the original data packet and extracts information required for inference analysis;
a flow information organization engine, configured to sort the packet parsing data based on flows; wherein the flow information organization engine obtains the information extracted from the packet parsing data from the packet parsing engine, organizes the information extracted into information of each flow by taking a flow determined by a five-tuple [source, IP address-destination, IP address-source, port-destination, port-protocol type] as a unit, and transmits the information required for the inference analysis in batches by taking the flow as the unit;
an inference analysis engine, configured to perform the inference analysis based on data of each piece of flow; wherein the inference analysis engine obtains batched inputs required by the inference analysis from the flow information organization engine, and obtains a batch of classification results after performing the inference analysis on the batched inputs by the Transformer-based model; and
a packet caching engine, configured to cache a packet and send the packet after obtaining the batch of classification results; wherein the packet caching engine obtains and caches the batch of classification results from the inference analysis engine, obtains the original data packet from the packet analysis engine, caches a data packet that requires to wait for the classification result, and sends a data packet of which a classification result is queried in the cache.

15. A non-transitory computer-readable storage medium for storing computer instructions, wherein the computer instructions are configured to cause a computer to execute a method, comprising:
obtaining a switch classification result by deploying a recurrent neural network on a P4 programmable switch to perform line-speed analysis on traffic;
forwarding a first part of traffic to a server for upgraded analysis based on the switch classification result and a classification confidence; and
performing the upgraded analysis on the first part of traffic by deploying a Transformer-based model on the server.

16. The non-transitory computer-readable storage medium of claim 15, wherein deploying the recurrent neural network on the P4 programmable switch to perform the line-speed analysis on the traffic comprises:
allocating an array subscript for storing flow information based on a hash value, and updating and maintaining the flow information;
embedding sequence information of a flow into a low-dimensional vector;
obtaining intermediate inference results by inference analysis of the recurrent neural network based on the low-dimensional vector sequence embedded;
aggregating the intermediate inference results to obtain the switch classification result and the classification confidence; and
determining whether the upgraded analysis is performed based on the switch classification result and the classification confidence.

17. The non-transitory computer-readable storage medium of claim 16, wherein allocating the array subscript for storing the flow information based on the hash value and updating and maintaining the flow information comprise:
calculating a hash value as an array subscript for storing the flow information based on five-tuple information [source, IP address-destination, IP address-source, port-destination, port-protocol type] of the flow;
storing a flow identifier and a timestamp of a last packet; and
updating and maintaining stored flow information by determining whether the flow identifier conflicts and whether the timestamp is timed out.

18. The non-transitory computer-readable storage medium of claim 16, wherein the sequence information is a packet length sequence and/or a packet time interval sequence of the flow; embedding the sequence information of the flow into the low-dimensional vector is embedding the packet length sequence and/or the packet time interval sequence into the low-dimensional vector sequence by look-up table.

19. The non-transitory computer-readable storage medium of claim 16, wherein obtaining the intermediate inference results by the inference analysis of the recurrent neural network based on the low-dimensional vector sequence embedded comprises:
setting a number of recurrent timesteps based on a hardware resource, and setting a length of a sliding window based on the number of recurrent timesteps;
storing the low-dimensional vector and updating a low-dimensional vector sequence within the sliding window; and
for the low-dimensional vector sequence, performing analysis calculations of recurrent timesteps continuously by look-up table to obtain the intermediate inference results.

20. The non-transitory computer-readable storage medium of claim 16, wherein aggregating the intermediate inference results to obtain the switch classification result and the classification confidence and determining whether the upgraded analysis is performed based on the switch classification result and the classification confidence comprise:
accumulating probabilities of each class in the intermediate inference results, selecting a class with a maximum cumulative probability as the switch classification result, and calculating the classification confidence based on a cumulative probability of the switch classification result and a number of intermediate inference results;
compressing a number of steps required to select the maximum cumulative probability by using an optimized ternary coding algorithm; and
comparing the classification confidence of the switch classification result with a preset confidence threshold, wherein in a case that the classification confidence is lower than the preset confidence threshold, the switch classification result is considered to be ambiguous; in a case that a number of ambiguous switch classification results exceeds a preset threshold, subsequent flow is forwarded to the server, and the Transformer-based model is employed for the upgraded analysis.
